(19) United States
(12) Patent Application Publication
(10) Pub. No.: US 2005/0218788 A1
(43) Pub. Date: Oct. 6, 2005

(54) Electron emission display

(76) Inventors: Dong-Su Jang, Yangsan (KR); Jae-Hoon Lee, Suwon (KR)

Correspondence Address: Robert E. Bushnell, Suite 300, 1522 K Street, N.W., Washington, DC, 20005, US

(21) Appl. No.: 11/085,262

(22) Filed: Mar. 22, 2005

(30) Foreign Application Priority Data
Mar. 31, 2004 (KR) 2004-22406

(51) Int. Cl. H01J 19/02

(52) U.S. Cl. 313/497

(57) ABSTRACT

An electron emission display includes: a rear plate including an electron emission device; a front plate spaced from the rear plate and including a fluorescent layer adapted to emit light in response to electrons emitted by the electron emission device colliding with the fluorescent layer; and a grid electrode arranged in a space between the rear and front plates and having a grid substrate including an aperture through which electrons emitted by the electron emission device pass and a film of a photo absorbing material arranged on a surface of the grid substrate. With this configuration, light from a fluorescent layer or secondary electrons, which travel towards a rear plate while the electron emission display operates, are absorbed in the blackened film to prevent other fluorescent layers from emitting light, thereby improving brightness and color purity of the electron emission display.

### CLAIM OF PRIORITY

This application makes reference to, incorporates the same herein, and claims all benefits accruing under 35 U.S.C. §119 from an application for ELECTRON EMISSION DISPLAY earlier filed in the Korean Intellectual Property Office on 31 Mar. 2004 and there duly assigned the Ser. No. 2004-22406.

### BACKGROUND OF THE INVENTION

1. Field of the Invention

The present invention relates to an electron emission display with a grid electrode, and more particularly, to an electron emission display with a grid electrode on which a blackened film is formed to prevent unwanted color from being created due to light emitted from a fluorescent layer excited by electrons emitted by an electron emission source and reflected from the grid electrode.

2. Discussion of Related Art

An electron emission display, which displays an image based on light emission of a fluorescent layer due to an electron beam, is classified into thermionic cathode devices for thermal electron emission and cold cathode devices for cold-cathode emission. Furthermore, cold cathode devices are classified into either Field Emitter Array (FEA) devices, Surface Conduction Emitter (SCE) devices, Metal-Insulator-Metal (MIM) devices, Metal-Insulator-Semiconductor (MIS) devices, or Ballistic Electron Surface Emitter (BSE) devices, according to the electron emission method.

The electron emission display has a triode structure comprising a cathode electrode, a gate electrode and an anode electrode. The electron emission display has become important since it has the advantages of low power consumption and a thin structure as compared with a Cathode Ray Tube (CRT).

An FEA electron emission display, a panel of the electron emission display comprises a front plate and a rear plate spaced apart by a predetermined distance with spacers, wherein the internal space between the front and rear plates is sealed by applying and annealing a frit and then the space is maintained in a vacuum by an exhausting process.

An inward surface of the rear plate includes a cathode electrode having a first line pattern, and gate electrode having a second line pattern perpendicular to the first line pattern. The gate electrode has a gate aperture formed at the intersection of the first and second line patterns. An electron emission source is provided on the surface of the cathode electrode and is exposed through the gate aperture. An insulator insulates the cathode electrode from the gate electrode.

An inward surface of the front plate is coated with Red (R), Green (G) and Blue (B) fluorescent materials having a predetermined pattern. An anode electrode and a dark layer or region for absorbing light is interposed between the adjacent patterns of the fluorescent materials. Furthermore, the front of the anode electrode may have a thin metal film of conductive material such as aluminum.

In the foregoing panel structure of the FEA electron emission display, a voltage difference between the gate electrode and the cathode electrode causes the electron emission source to emit electrons (e⁻). The emitted electrons passes through the gate aperture and are accelerated toward the front plate by the relative high voltage applied to the anode electrode so as to collide with the fluorescent materials. The fluorescent materials are excited to emit light by the electron collisions, thereby displaying a predetermined image.

While the FEA electron emission display operates as mentioned above, a vacuum discharge is generated in the internal space. When the vacuum discharge becomes an arc discharge, the panel structures formed in the internal space, such as the anode and gate electrodes, are damaged by, for example, being electrically shorted, so that there arises a problem in that the electron emission display operation is deteriorated.

To solve the foregoing problem, a technology has been developed where a metallic grid electrode is provided in an internal space between a gate electrode and an anode electrode in order to ground a current generated by the vacuum discharge in the internal space.

Electrons emitted from the electron emission source pass through a gate aperture formed in the gate electrode and an aperture formed in the grid electrode in sequence due to the high voltage applied to the anode electrode, and then collide with the fluorescent layer, thereby displaying a predetermined image. A grid holder supports the grid electrode.

However, light emitted from the fluorescent layer by electron collisions and/or secondary electrons generated due to the electron collisions, partially travels toward the rear plate reflects off the surface of the grid electrode and travels toward another fluorescent layer, thereby creating an unwanted color and thus deteriorating the color purity of the electron emission display.

Korean Patent Publication Number 2003-0079270, having the same assignee as that of the present application, relates to a field emission display and apparatus and method for manufacturing the same. The display and apparatus and manufacturing method uniformly mount components regardless of the size of the substrate, while avoiding interference between components. While this reference has features in common with the present invention, it does not teach or suggest the specifically recited elements of the present invention.

### SUMMARY OF THE INVENTION

Accordingly, it is an object of the present invention to provide an electron emission display with a grid electrode on which a blackened film is formed as an absorbing layer to absorb light or electrons to prevent color purity from being deteriorated, wherein the color purity is likely to become deteriorated accordingly as the light emitted from a fluorescent layer when electrons collide with the fluorescent layer or secondary electrons generated due to electron collisions, which partially travel toward a rear plate reflect from the surface of the grid electrode and travel toward other fluorescent layers to emit light.

The foregoing and/or other aspects of the present invention are achieved by providing an electron emission display comprising: a rear plate including an electron emission device; a front plate spaced from the rear plate and including a fluorescent layer adapted to emit light in response to electrons emitted by the electron emission device colliding with the fluorescent layer; and a grid electrode arranged in a space between the rear and front plates and having a grid substrate including an aperture through which electrons emitted by the electron emission device pass and a film of a photo absorbing material arranged on a surface of the grid substrate.

The grid substrate preferably comprises SUS, invar, or iron steel.

The photo absorbing film preferably has a thickness of 0.5˜3 μm.

The photo absorbing film comprises an oxidized surface of the grid substrate.

The photo absorbing film is preferably arranged on opposite sides of the grid substrate.

The photo absorbing film is preferably arranged on an inner surface of the aperture in the grid substrate.

The electron emission device preferably includes an electron emission source comprised of an electron emission constituent.

The electron emission constituent preferably comprises a carbon material.

The electron emission constituent preferably has nano-scale dimensions.

The electron emission constituent preferably comprises Carbon Nano-Tubes (CNT).

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a sectional view illustrating a structure of an FEA electron emission display;

FIG. 2 is a sectional view illustrating an FEA electron emission display with a grid electrode;

FIG. 3A is a perspective view of a grid electrode formed with a blackened film according to an embodiment of the present invention;

FIG. 3B is a sectional view of the grid electrode, taken along line IV-IV in FIG. 3A;

FIG. 4 is a sectional view of a grid electrode formed with a blackened film at opposite sides thereof according to an embodiment of the present invention;

FIG. 5 is a sectional view of an electron emission display with a grid according to an embodiment of the present invention;

FIG. 6 is a sectional view of a function of the grid electrode in the electron emission display according to an embodiment of the present invention;

FIG. 7 is a sectional view of the electron emission display employing a grid electrode according to an embodiment of the present invention; and

FIG. 8 is a perspective view of an electrode according to another embodiment of the present invention.

### DETAILED DESCRIPTION OF INVENTION

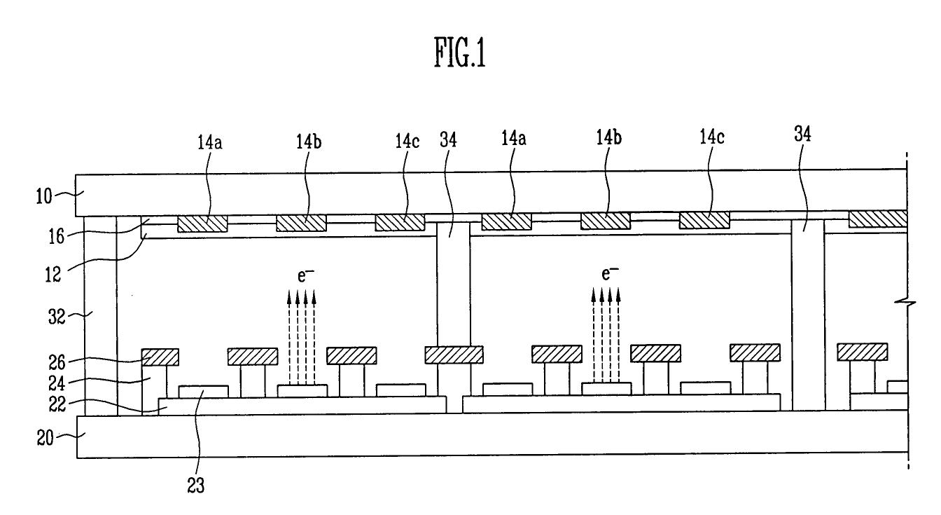

Referring to FIG. 1, schematically illustrating an FEA electron emission display, a panel of the electron emission display comprises a front plate 10 and a rear plate 20 spaced apart by a predetermined distance with spacers 34, wherein the internal space between the front and rear plates 10 and 20 is sealed by applying and annealing a frit 32 and then the space is maintained in a vacuum by an exhausting process.

An inward surface of the rear plate 20 includes a cathode electrode 22 having a first line pattern, and gate electrode 26 having a second line pattern perpendicular to the first line pattern. The gate electrode 26 has a gate aperture formed at the intersection of the first and second line patterns. An electron emission source 23 is provided on the surface of the cathode electrode 22 and is exposed through the gate aperture. An insulator 24 insulates the cathode electrode 22 from the gate electrode 26.

An inward surface of the front plate 10 is coated with Red (R), Green (G) and Blue (B) fluorescent materials 14a, 14b and 14c having a predetermined pattern. An anode electrode 12 and a dark layer or region 16 for absorbing light is interposed between the adjacent patterns of the fluorescent materials 14a, 14b and 14c. Furthermore, the front of the anode electrode 12 may have a thin metal film of conductive material such as aluminum.

In the foregoing panel structure of the FEA electron emission display, a voltage difference between the gate electrode 26 and the cathode electrode 22 causes the electron emission source 23 to emit electrons (e⁻). The emitted electrons passes through the gate aperture and are accelerated toward the front plate 10 by the relative high voltage applied to the anode electrode 12 so as to collide with the fluorescent materials 14a, 14b and 14c. The fluorescent materials 14a, 14b and 14c are excited to emit light by the electron collisions, thereby displaying a predetermined image.

While the FEA electron emission display operates as mentioned above, a vacuum discharge is generated in the internal space. When the vacuum discharge becomes an arc discharge, the panel structures formed in the internal space, such as the anode and gate electrodes, are damaged by, for example, being electrically shorted, so that there arises a problem in that the electron emission display is deteriorated.

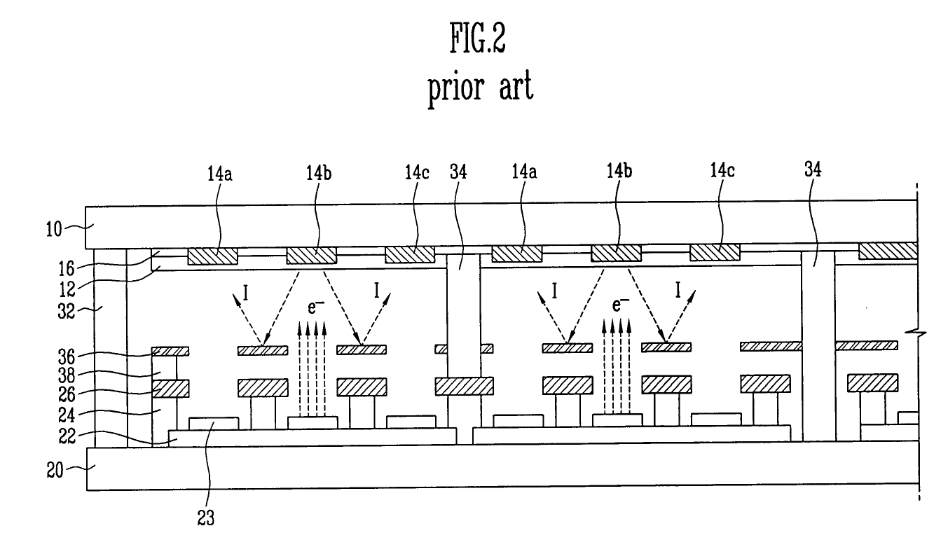

Referring to FIG. 2, to solve the foregoing problem, a technology has been developed where a metallic grid electrode 36 is provided in an internal space between a gate electrode 26 and an anode electrode 12 in order to ground a current generated by the vacuum discharge in the internal space.

Electrons emitted from the electron emission source 23 pass through a gate aperture formed in the gate electrode 26 and an aperture formed in the grid electrode 36 in sequence due to the high voltage applied to the anode electrode 12, and then collide with the fluorescent layer, thereby displaying a predetermined image. A grid holder 38 supports the grid electrode 36.

However, referring to arrow ‘I’ in FIG. 2, light emitted from the fluorescent layer (e.g., 14b) by electron collisions and/or secondary electrons generated due to the electron collisions, partially travels toward the rear plate 20, reflects off the surface of the grid electrode and travels toward another fluorescent layer (e.g., 14a or 14c), thereby creating an unwanted color and thus deteriorating the color purity of the electron emission display.

Hereinafter, exemplary embodiments of the present invention are described in detail with reference to the accompanying drawings.

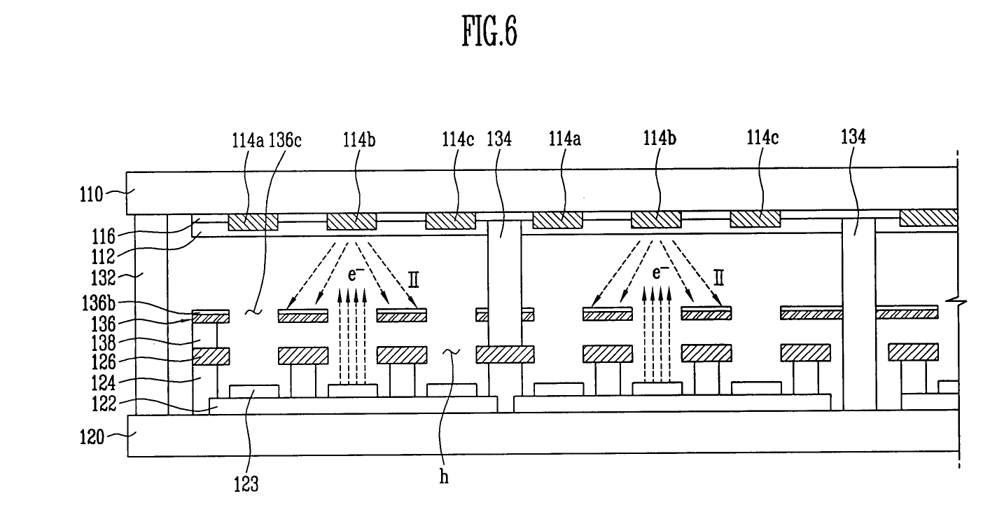

Referring to FIG. 5, an electron emission display comprises a front plate 10 and a rear plate 120, separated a predetermined distance apart by spacers 134 and facing each other. The internal space between the front and rear plates 110 and 120 is sealed by applying and annealing a frit 132 to define a boundary therebetween and then the space is maintained at a high vacuum by an exhausting process.

An inward surface of the rear plate 120 facing the front plate 110 includes a cathode electrode 122 having a first line pattern and gate electrode 126 having a second line pattern perpendicular to the first line pattern. An insulator 124 having a predetermined thickness is arranged between the electrodes 122 and 126. The gate electrode 126 is formed with gate aperture ‘h’ having a size as large as electrons that pass therethrough and positioned at the intersection of the first and second line patterns. The surface of the cathode electrode 122, which is exposed through the gate aperture ‘h’, is provided with electron emission source 123 emitting electrons.

The electron emission source 123 can be made not only of Molybdenum (Mo), Silicon (Si), and the like, but can also be made of carbon materials such as graphite, or Diamond like Carbon (DLC), or an electron emission constituent including a carbon material. Furthermore, such material preferably has nano-scale dimensions like a nanotube or a nanowire. In the drawings, the electron emission source 123 is illustrated as having a planar shape, but it is not limited thereto, and can have a tipped shape.

An inward surface of the front plate 110 facing the rear plate 120 is coated with Red (R), Green (G) and Blue (B) fluorescent materials 114a, 114b and 114c, which emit light when electrons emitted from the electron emission source 123 arranged in the rear plate 120 collides therewith. The fluorescent materials 114a, 114b and 114c are coated in a stripe or dot pattern. A dark region 116 for absorbing light is interposed between the adjacent fluorescent patterns 114a, 114b and 114c, wherein the dark region 116 has a matrix or striped shape. The entire area of the fluorescent patterns 114a, 114b and 114c and the dark region 116 is covered by an anode electrode 112. The anode electrode 112 is formed throughout the front plate 110 or has a predetermined pattern. Alternatively, the fluorescent patterns 114a, 114b and 114c and the dark region 116 can be covered by a thin metal film instead of the anode electrode, wherein the thin metal film is employed as the anode electrode.

The fluorescent patterns 114a, 114b and 114c and the dark region 116 can be formed by electrophoresis, screen-printing, slurring, or a similar method.

Furthermore, a grid electrode 136 is provided above the gate electrode 126 to focus the electrons emitted from the electron emission source 123 and passing through the gate aperture ‘h’ onto the fluorescent patterns 114a, 114b and 114c.

The edges of the grid electrode 136 are supported by a grid holder 138 arranged above the rear plate 120. In the drawings, the grid holder 138 is disposed on the gate electrode 126. However, the present invention is not limited thereto.

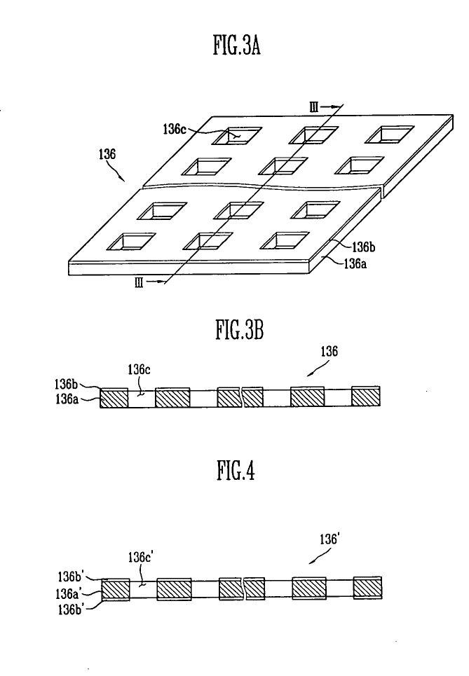

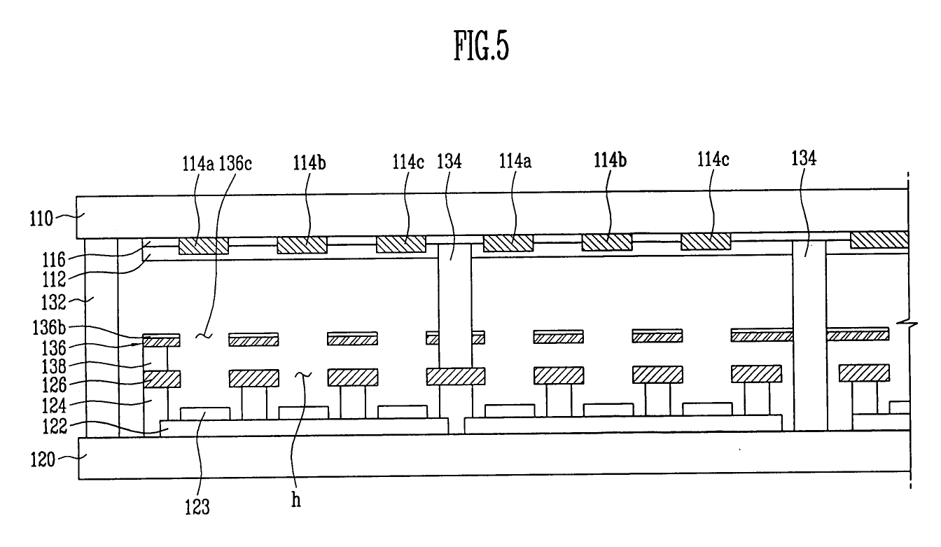

According to an embodiment of the present invention, as shown in FIGS. 3A and 3B, the grid electrode 136 comprises a grid substrate 136a having apertures through which electrons pass. The grid substrate 136a is coated with a thin film, for example, a blackened film 136b, forming a photo absorbing layer to absorb light electrons, and/or secondary electrons.

The grid substrate 136a of the grid electrode 136 has a plurality of apertures 136c (to be described later) through which electrons emitted by the electron emission source 123 pass. Preferably, the position at which the aperture 136c is formed corresponds to the intersection of the cathode electrode and the gate electrode.

The grid substrate 136a is of a conductive material including stainless steel, such as SUS or invar, or iron steel. Preferably, the grid substrate 136a is of a conductive material having a thermal expansion coefficient equal to or at least similar to that of glass, i.e., a material forming the frit or the plates. This is because the thermal expansion of the grid substrate 136a should be similar to that of the glass structure forming the electron emission display during an annealing process (to be described later).

In this embodiment, the thin film formed on the grid substrate 136a is illustrated as being a blackened film 136b obtained by oxidizing the surface of the grid substrate 136a. However, the thin film is not limited thereto, and may include other thin films capable of absorbing light electrons, and/or secondary electrons.

Referring to FIG. 4, a grid electrode 136′ according to an embodiment of the present invention, comprises a grid substrate 136a′ and blackened films 136b′ formed on opposite sides of the grid substrate 136a′. Furthermore, the grid electrode 136′ has a plurality of apertures 136c′ through which electrons pass.

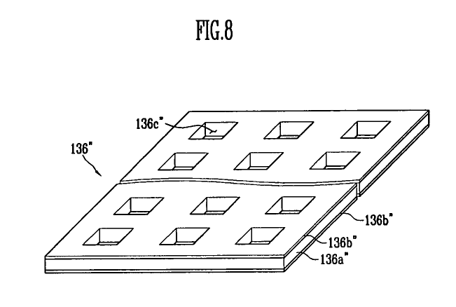

The blackened films 136b and 136b′ can be formed only on the surface of the grid substrate 136a as shown in FIGS. 3A, 3B and 4, or can be formed on an inner surface of the aperture 136c and 136c′ as shown in FIG. 8. The blackened films 136b and 136b′ preferably have a thickness of 0.1˜5 μm, and more preferably have a thickness of 0.5˜3 μm. When the blackened films 136b and 136b′ are relatively thin, light and/or secondary electrons are not effectively absorbed. Conversely, when the blackened films 136b and 136b′ are relatively thick, the absorption effect is not further improved.

As described above, the blackened film 136b is formed by an oxidization process or steam process for treating the surface of the grid substrate 136a, which is made of a material containing iron (Fe), e.g., a stainless steel such as SUS or invar, or iron steel.

In the oxidization process, air is mixed with Liquefied Natural Gas (LNG) or propane (C₃H₅) gas at a predetermined ratio, and the mixed gas is ignited to create DX-gas. The DX-gas is injected into a blackening furnace, and the grid substrate is loaded into the furnace and then heated to a temperature of 570 or more. Iron contained in the grid substrate reacts with the DX-gas in the furnace, thereby forming the blackened film.

The DX-gas is created by incompletely igniting the mixed gas of air and LNG having a ratio of about 13:1, or incompletely igniting the mixed gas of air and propane gas having a ratio of about 9.7:1. The DX-gas includes CO₂ (about 12.4%), CO (about 0.7%), H₂ (about 0.3%), O₂ (below about 0.02%), and the balance being N₂.

In the steam process, steam instead of the DX-gas is injected into the furnace heated to a temperature of 570 or more.

Table 1 below indicates an oxidative reaction formula of Fe according to the temperature, wherein the surface of the grid substrate 136a is blackened by a final oxide as shown in <Table 1>.

TABLE 1

| 570 or more | 570 below |
|---|---|
| Fe + CO₂ FeO + CO | 3Fe + 4 CO₂ Fe3O₄ + 4CO |
| 3FeO + CO₂ Fe₃O₄ + CO | |
| Fe + H₂O FeO + H₂ | 3Fe + 4H₂O Fe₃O4 + 4H₂ |
| 3FeO + H₂O Fe₃O₄ + H₂ | |

In <Table 1>, FeO is opaque and black, while Fe₃O₄ is black and has a dense microstructure and hard characteristics. That is, the final oxide is waterproof and useful.

When the grid substrate is annealed before loaded into the furnace, chrome (Cr) of the grid substrate is enriched and then oxidized, thereby forming a passivation film having good corrosion resistance. The passivation film inhibits an oxide film from growing. Therefore, in the next process, the annealed grid substrate is cooled under a reduction atmosphere to reduce the oxidized chrome layer.

For example, in the blackening process, the grid substrate is heated in the furnace to a temperature of about 580 for 10˜20 minutes, and then cooled in a cooling chamber. That is, the blackening gas (e.g., DX-gas) created by incompletely igniting the mixing gas of air and LPG or the liquefied propane gas in a burner is supplied to the high-temperature furnace, thereby depositing a blackened material on the grid substrate in the high temperature atmosphere. After depositing the blackened material, it is heat-treated, thereby forming the blackened film on the surface of the grid substrate.

The heat treatment of the blackened material is performed in an inert atmosphere of hydrogen or argon (Ar) gas, or a vacuum atmosphere, thereby preventing the metal surface of the grid substrate from being oxidized due to oxygen. Furthermore, the heat treatment of the substrate is performed at a temperature of 500˜700 approximating the recrystallization temperature of the iron steel, in mixed gas atmosphere of city gas, nitrogen gas, and oxygen gas, so that the superficial surface of the grid substrate is blackened, thereby forming an blackened film. Consequently, the blackened film is formed as a mixed compound layer.

Preferably, the blackened film has a thickness of 0.5 μm-3 μm. Too thick a blackened film deteriorates its cohesiveness. Contrarily, too thin a blackened film deteriorates its heat radiation effect and vacuum characteristics, so that a gas may be generated.

The thermal radiation of the blackened film is relatively high, so that the temperature of the grid electrode is prevented from being increased, thereby effectively decreasing the thermal expansion thereof.

The blackened film 136b comprises FeOₓ as a spinel-type oxide formed by oxidizing the Fe of the stainless steel, and CrOₓ as a corundum-type oxide formed by oxidizing Cr of the stainless steel through the hydrogen heat-treatment. The spinel-type oxide is partially spread into oxide solder glass, thereby increasing the affinity between an oxide layer and the solder glass. Furthermore, the corundum-type oxide increases density and cohesiveness between the basic metal and the oxide layer.

Thus, the grid electrodes 136 and 136′ formed by the foregoing processes are arranged between the rear plate 120 and the front plate 110 of the electron emission display by any well-known method, wherein the blackened film of the grid electrodes 136 and 136′ prevents the iron from being stained, and light and an electron beam from diffused reflection, and also enhances thermal conductivity due to thermal absorption.

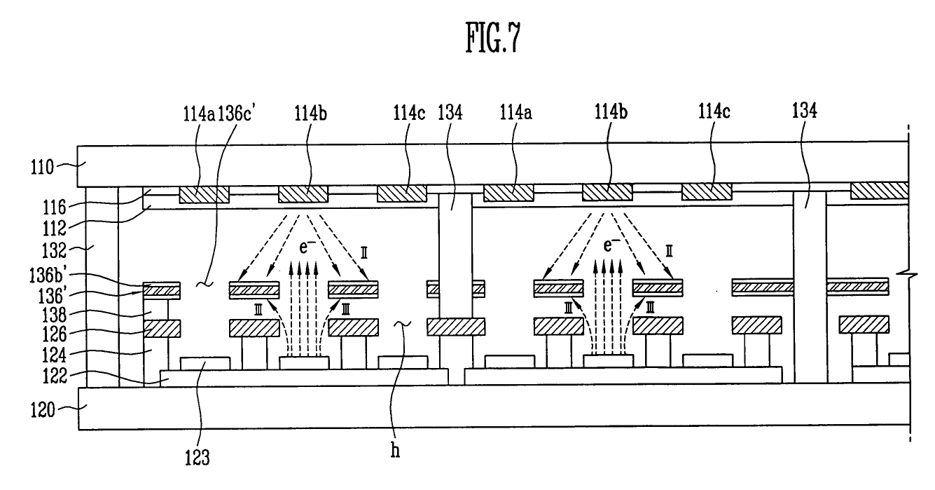

Herein below, the operation of the electron emission display is described with reference to FIGS. 6 and 7.

First, when a gate voltage is applied between the cathode electrode 122 and the gate electrode 126, the electron emission source 123 on the cathode electrode 122 emits electrons. Furthermore, an anode voltage applied between the cathode electrode 122 and the anode electrode 112 allows the emitted electrons to pass through the gate aperture ‘h’ of the gate electrode 126 and the aperture 136c of the grid electrode 136 and to be accelerated toward the front plate 110. Then, when the electrons collide with the fluorescent layer (e.g., 114b), the fluorescent layer 114b is excited and emits light. Then, the light emitted from the fluorescent layer 114b travels toward the front plate 110, thereby displaying a predetermined image.

On the other hand, the light emitted from the fluorescent layer 114b or secondary electrons generated by electron collisions, which partially travel toward the rear plate 120 along arrow ‘II’ as illustrated in FIG. 6, are absorbed by the blackened film 136b formed on the grid electrode 136 without being reflected. Consequently, the color purity of the electron emission display is enhanced, thereby improving picture realization.

According to another embodiment of the present invention, when a grid electrode 136′ having a blackened film 136b′ on opposite sides thereof is arranged in an internal space of the electron emission display, the blackened film 136b′ formed on the top surface of the grid electrode 136b′ absorbs light emitted from the fluorescent layer 114b or secondary electrons generated by electron collisions, which travel in a direction towards the rear plate 120 (refer to arrow ‘II’ in FIG. 7).

The blackened film 136b′ formed on the bottom surface of the grid electrode 136′ absorbs electrons emitted by the electron emission source 123, which do not pass through the aperture 136c′ of the grid electrode 136′ and are deflected (refer to arrows ‘III’ in FIG. 7).

As described above, the present invention includes a grid electrode with a blackened film, so that light from a fluorescent layer or a secondary electrons, which travel towards a rear plate while the electron emission display operates, are absorbed in the blackened film to prevent another fluorescent layer from emitting light, thereby improving brightness and color purity of the electron emission display.

Although exemplary embodiments of the present invention have been shown and described, it would be appreciated by those skilled in the art that modifications may be made to this embodiment without departing from the principles and spirit of the present invention, the scope of which is defined in the claims below.

1. An electron emission display comprising:
a rear plate including an electron emission device;
a front plate spaced from the rear plate and including a fluorescent layer adapted to emit light in response to electrons emitted by the electron emission device and colliding with the fluorescent layer; and
a grid electrode arranged in a space between the rear and front plates and having a grid substrate including an aperture through which electrons emitted by the electron emission device pass and a film of a photo absorbing material arranged on a surface of the grid substrate.

2. The electron emission display according to claim 1, wherein the grid substrate comprises SUS, invar, or iron steel.

3. The electron emission display according to claim 1, wherein the photo absorbing film has a thickness of 0.5˜3 μm.

4. The electron emission display according to claim 1, wherein the photo absorbing film comprises an oxidized surface of the grid substrate.

5. The electron emission display according to claim 2, wherein the photo absorbing film comprises an oxidized surface of the grid substrate.

6. The electron emission display according to claim 3, wherein the photo absorbing film is arranged on opposite sides of the grid substrate.

7. The electron emission display according to claim 1, wherein the photo absorbing film is arranged on an inner surface of the aperture in the grid substrate.

8. The electron emission display according to claim 1, wherein the electron emission device includes an electron emission source comprised of an electron emission constituent.

9. The electron emission display according to claim 8, wherein the electron emission constituent comprises a carbon material.

10. The electron emission display according to claim 8, wherein the electron emission constituent has nano-scale dimensions.

11. The electron emission display according to claim 8, wherein the electron emission constituent comprises Carbon Nano-Tubes (CNT).
